(19) United States
(12) Patent Application Publication
(10) Pub. No.: US 2026/0037895 A1
(43) Pub. Date: Feb. 5, 2026

(54) LAND SITE TOOL FOR CONVEYING AND ACTING ON INDICATION TO INTERESTED PARTIES OF RISKS AND OPPORTUNITIES OF ABILITY OF LAND SITES, INCLUDING SOLAR SITES, IN SUSTAINING VEGETATION THEREON

(71) Applicant: PROFILE PRODUCTS LLC, BUFFALO GROVE, IL (US)

(72) Inventors: Matthew Michael WELCH, Menasha, WI (US); Stephen Robert MACSHANE, Huntley, IL (US); Adam M. FREEDGOOD, Morristown, NJ (US); Laura Elise SCHUMACHER, Charlotte, NC (US); Adam L. DIBBLE, Harrison Township, MI (US)

(73) Assignee: PROFILE PRODUCTS LLC, BUFFALO GROVE, IL (US)

(21) Appl. No.: 19/286,740

(22) Filed: Jul. 31, 2025

Related U.S. Application Data
(60) Provisional application No. 63/677,709, filed on Jul. 31, 2024.

(51) Int. Cl. G06Q 10/0635

(52) U.S. Cl. CPC G06Q 10/0635

(57) ABSTRACT

A method for use with a database having risk scores for land points indicative of a chance for vegetation on the land points to be sustained includes receiving a risk score of a land area, the risk score of the land area being based on the risk scores of land points forming the land area. A test depending on the risk score of the land area for testing the land area to ascertain physical characteristics of the land area is identified and the land area is tested according to the test to ascertain the physical characteristics of the land area and determine therefrom the chance for vegetation on the land area to be sustained. A plan to remediate the land area depending on the risk score and/or on the physical characteristics may be developed. The database may have a listing of candidate solar facility land sites and risk scores.

### CROSS-REFERENCE TO RELATED APPLICATIONS

This application claims the benefit of U.S. Provisional Application No. 63/677,709, filed Jul. 31, 2024, the disclosure of which is hereby incorporated in its entirety by reference herein.

### TECHNICAL FIELD

The present invention relates to methods and systems for promoting early action for vegetation management or establishment, erosion control, and stormwater best management practices on land sites including solar sites.

### BACKGROUND

Geophysical development challenges of a land site, such as a land site for a solar facility, relate directly to the characteristics of the land, the soil, and the precipitation of the site. When it comes to precipitation, patterns are increasingly influenced by climate change, which affects duration, intensity, and storm totals. The kind of extreme precipitation that is now present is a relatively new phenomenon. Terrain variables that go into a stormwater plan are interrelated and include slope and soil texture.

Research-backed tools have identified solar-specific, erosion and sediment control best management practices (BMPs) that apply to solar site construction. These BMPs include compaction—managing soil compaction and bulk density across the site; soil depth—including soil depth (rooting depth) in stormwater modeling and design; ground cover—installing, establishing, and maintaining appropriate vegetated ground cover between and under the solar arrays to facilitate infiltration; and disconnection—ensuring appropriate distance between solar arrays for infiltration.

Despite best practices that apply to the site design, engineering, and construction phases, there is no single tool or approach to prioritize interventions from the earliest stages in the solar site development process—long before typical problems manifest. In fact, many utility-scale solar projects proceed to the bid and construction stage with inadequate pre-construction stormwater and soil erosion control considerations, only to require extensive—and costly—remediation later.

Erosion problems can begin in the early stages of construction of a solar site and persist long after the PTO (permission to operate) is issued. It is common to encounter site personnel who are dealing with persistent erosion problems that could have been prevented through a series of holistic strategies involving vegetative solutions that promote soil health. Other problems that could have been prevented through vegetative solutions include problems related to land use or adjacent factors (near a wetland, in a flood zone, used to be a forest).

Well-designed solar sites, in addition to mitigating soil erosion, can improve nearby ecosystem quality in several ways when compared to previous site conditions. Solar sites constructed with robust erosion control measures protect clean drinking water by preventing soil loss which contributes to turbidity, nutrient pollution, and chemical pollution of drinking water sources, fisheries, and recreational waterways. On the ground, solar sites with native plant species support biodiversity by increasing the vitality of local insect populations compared with previous site uses such as monoculture agriculture, brownfields, and barren land. Solar sites with native plants can also directly benefit surrounding agriculture by improving pollinator counts, leading to positive environmental and economic return-on-investment for farmers in a range (for example, a range of 1.5 km) around a solar site, in addition to community engagement benefits for developers.

### SUMMARY

Embodiments of the present invention provide a land site tool (or solar site tool) for promoting early action for vegetation, erosion control, and stormwater best management practices on land sites including solar sites.

A method for use with the land site tool is provided. The land site tool includes a database having a risk score for each of a plurality of land points with the risk score for a land point being indicative of a chance for vegetation on the land point to be sustained. The method includes selecting, such as by a user of the land site tool, a group of land points forming an area of land. The method further includes receiving, such as by the user and such as from the land site tool, a risk score of the land area indicative of a chance for vegetation on the land area to be sustained. The risk score of the land area, determinable by the land site tool, is based on the risk scores of the land points forming the land area. The method further includes identifying, such as by the user and/or by a provider of the land site tool, a test depending on the risk score of the land area for testing the land area to ascertain physical characteristics of the land area. The method further includes testing, such as with the authority of and/or by the user and/or the provider, the land area according to the test to ascertain the physical characteristics of the land area and determine therefrom the chance for vegetation on the land area to be sustained.

The method may further include remediating, such as with the authority of and/or by the user and/or the provider, the land area according to the physical characteristics of the land area to increase the chance for vegetation on the land area to be sustained.

Alternatively, the method may further include receiving, such as by the user and such as from the provider, a recommendation, depending on the risk score of the land area and/or on the physical characteristics of the land area, indicative on how to remediate the land area to increase the chance for vegetation on the land area to be sustained. In this case, the method may further include remediating, such as with the authority of and/or by the user and/or the provider, the land area according to the recommendation.

In an embodiment, the step of receiving a risk score of the land area may include receiving a risk score of a first portion of the land area based on the risk scores of the land points forming the first portion of the land area and receiving a risk score of a second portion of the land area based on the risk scores of the land points forming the second portion of the land area. The step of identifying a test may include identifying a first test depending on the risk score of the first portion of the land area and identifying a different second test depending on the risk score of the second portion of the land area. The step of testing the land area may include testing the first portion of the land area in a first manner according to the first test and testing the second portion of the land area in a second manner according to the different second test. The step of determining from the physical characteristics of the land area may include determining from physical characteristics of the first portion of the land area ascertained from the testing of the first portion of the land area the chance for vegetation on the first portion of the land area to be sustained and determining from physical characteristics of the second portion of the land area ascertained from the testing of the second portion of the land area the chance for vegetation on the second portion of the land area to be sustained.

In this embodiment, the method may further include receiving, such as by the user and such as from the provider, a recommendation, depending on the risk scores of the first and second portions of the land area and/or on the physical characteristics of the first and second portions of the land area, indicative on how to remediate the first and second portions of the land area to increase the chance for vegetation on the first and second portions of the land area to be sustained. In this case, the method may further include, such as with the authority of and/or by the user and/or the provider, at least one of the first and second portions of the land area according to the recommendation.

A method for use with the land site tool as a solar site tool is provided. The solar site tool includes a database having a listing of land sites that are candidates for a solar facility to be developed on land thereof and having for each land site a risk score that is indicative of a chance for vegetation on the land site to be sustained. The method includes selecting, such as by a user of the solar site tool, a land site from the listing. The method further includes receiving, such as by the user and such as from a provider of the solar site tool, the risk score of the land site. The method further includes identifying, such as by the user and/or by the provider, a test depending on the risk score of the land site for testing the land site to ascertain physical characteristics of the land site. The method further includes testing, such as with the authority of and/or by the user and/or the provider, the land site according to the test to ascertain the physical characteristics of the land site and determine therefrom the chance for vegetation on the land site to be sustained.

The method may further include receiving, such as by the user and such as from the provider, a recommendation, depending on the risk score of the land site and/or on the physical characteristics of the land site, indicative on how to remediate the land site to increase the chance for vegetation on the land site to be sustained. In this case, the method may further include remediating, such as with the authority of and/or by the user and/or the provider, the land site according to the recommendation.

The database may further have for each land site (i) an erosion score that is indicative of a degree of erosion expected for soil of the land site and (ii) a soil health score that is indicative of a health of the soil of the land site. In this case, the risk score of the land site is a compound score of the erosion score and the soil health score, and the recommendation is further indicative on how to remediate the land site to lessen the degree of erosion expected for the soil of the land site and improve the health of the soil of the land site to increase the chance for vegetation on the land site to be sustained.

The database may further have for each land site an indication of an amount and a type of pollinator-dependent cropland within a given proximity of the land site. In this case, the recommendation is further indicative on how to remediate the land site, in a manner consistent with the chance for vegetation on the land site to be sustained being increased, depending on the amount and the type of the pollinator-dependent cropland to increase pollination activities originating from the land site onto the pollinator-dependent cropland.

A method for facilitating usage of land with the use of the land site tool is provided. The method includes providing, such as by a provider, the land site tool. As indicated, the land site tool includes a database having a risk score for each of a plurality of land points with the risk score for a land point is indicative of a chance for vegetation on the land point to be sustained. The method further includes receiving, such as by the land site tool, from a user, a selection of a group of the land points forming an area of land. The method further includes determining, such as by the land site tool, based on the risk scores of the land points forming the land area, a risk score of the land area indicative of a chance for vegetation on the land area to be sustained. The method further includes providing, such as by the land site tool, to the user, the risk score of the land area. The method further includes developing, such as with the authority of and/or by the provider and/or the user, a plan to remediate the land area depending on the risk score of the land area and/or on physical characteristics of the land area to increase the chance for vegetation on the land area to be sustained. The physical characteristics of the land area are ascertained from a physical test of the land area.

The step of developing a plan to remediate the land area may include providing to the user a recommendation, such as by the provider, depending on the risk score of the land area and/or on the physical characteristics of the land area, indicative of one or more products which when applied to the land area will increase the chance for vegetation on the land area to be sustained. In this case, the method may further include applying, such as with the authority of and/or by the provider and/or the user, to the land area the one or more products according to the recommendation.

A method for facilitating usage of land sites as solar facilities with the use of the solar site tool is provided. The method includes providing, such as by a provider, the solar site tool. As indicated, the solar site tool includes a database having a listing of land sites that are candidates for a solar facility to be developed thereon and further having for each land site a risk score that is indicative of a chance for vegetation on the land site to be sustained. The method includes receiving, such as by the solar site tool, from a user, a selection of a land site from the listing. The method further includes providing, such as by the solar site tool, to the user, the risk score of the land site. The method further includes developing, such as with the authority of and/or by the provider and/or the user, a plan to remediate the land site depending on the risk score of the land site and/or on physical characteristics of the land site to increase the chance for vegetation on the land site to be sustained. The physical characteristics of the land site are ascertained from a physical test of the land site.

The step of developing a plan to remediate the land site may include providing to the user a recommendation, such as by the provider, depending on the risk score of the land site and/or on the physical characteristics of the land site, indicative of one or more products which when applied to the land site will increase the chance for vegetation on the land site to be sustained, the one or more products including at least one product for controlling (i.e., minimizing or eliminating) erosion and/or at least one product for controlling (i.e., improving) soil health. In this case, the method may further include applying, such as with the authority of and/or by the provider and/or the user, to the land site the one or more products according to the recommendation. Concerning the products for controlling erosion and soil health, it is noted that unlike erosion, which is desired to be controlled or minimized with the use of appropriate products, soil health is a dynamic metric that fluctuates over time and is desired to be improved, with the use of appropriate products. Improved soil health will yield more sustainable vegetation, which improves land resistance to erosion.

The one or more products may include the at least one product for controlling erosion. The at least one product for controlling erosion may include at least one of a hydraulically applied erosion control product, a straw mulch, a hydraulic mulch, a bonded fiber matrix, an engineered fiber matrix, an erosion control blanket, a flexible growth medium, and a turf reinforcement mat.

The one or more products may include the at least one product for controlling (i.e., improving) soil health. The at least one product for controlling soil health may include at least one of a fertilizer, a soil neutralizer, an organic matter, a growth stimulator, an inoculant, and a biotic soil medium.

The one or more products may further include at least one seed product that is a source of the vegetation.

The database may further have for each land site an erosion score that is indicative of a degree of erosion expected for soil of the land site. In this case, the risk score of the land site depends on the erosion score of the land site, and the one or more products includes at least erosion control product which when applied to the land site will lessen the degree of erosion expected for the soil of the land site to increase the chance for vegetation on the land site to be sustained.

In this case, the database may further have for each land site a plurality of erosion factors. The erosion score for each land site depends on the erosion factors of the land site. The erosion factors for each land site include a rainfall erosivity of the land site, a soil erodibility of the land site, a slope of the land site, and an expected change in precipitation of the land site due to climate change.

The database may further have for each land site a soil health score that is indicative of a health of soil of the land site. In this case, the risk score of the land site depends on the soil health score of the land site, and the one or more products includes at least soil health control product which when applied to the land site will improve the health of the soil of the land site to increase the chance for vegetation on the land site to be sustained.

In this case, the database may further have for each land site a plurality of soil health factors. The soil heath score for each land site depends on the soil health factors of the land site. The soil health factors for each land site includes a pH of the soil of the land site, a soil organic matter (SOM) content of the soil of the land site, and a sodium adsorption ratio (SAR) of the soil of the land site.

The database may further have for each land site an indication of an amount and a type of pollinator-dependent cropland within a given proximity of the land site. In this case, the one or more products includes at least pollinator enhancement product, depending on the amount and the type of the pollinator-dependent cropland, which when applied to the land site will increase pollination activities originating from the land site onto the pollinator-dependent cropland in a manner consistent with the chance for vegetation on the land site to be sustained being increased.

### BRIEF DESCRIPTION OF THE DRAWINGS

FIG. 1A illustrates a map, generatable and displayable by the solar site tool, that is indicative of the erosion risk scores at locations across the continental United States;

FIG. 1B illustrates a map, generatable and displayable by the solar site tool, that is indicative of the soil health risk scores at locations across the continental United States;

FIGS. 2A, 2B, 2C, 2D, and 2E are a set of exemplary illustrations depicting, in a table format, various land site data that is stored in a database of the solar site tool;

FIGS. 3A, 3B, 3C, 3D, 3E, 3F, 3G, and 3H are a set of exemplary illustrations depicting site report segments of an individual site report provided by the solar site tool to a user requesting risk assessment information concerning a site;

FIG. 4A illustrates a flowchart depicting operation of a user when using the solar site tool for an arbitrary land area;

FIG. 4B illustrates a flowchart depicting operation of a user when using the solar site tool for a solar site from a listing of solar sites;

FIG. 4C illustrates a flowchart depicting operation of a service provider associated with the solar site tool when a user uses the solar site tool for an arbitrary land area; and

FIG. 4D illustrates a flowchart depicting operation of a service provider associated with the solar site tool when a user uses the solar site tool for a solar site from a listing of solar sites.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of components. Therefore, specific structural and functional details disclosed herein are not to be interpreted as limiting, but merely as a representative basis for teaching one skilled in the art to variously employ the present invention.

Embodiments of the present invention provide a land site tool for promoting early action for vegetation, erosion control, and stormwater best management practices on land sites. In embodiments, the land site tool is a solar site tool for promoting early action for vegetation, erosion control, and stormwater best management practices on solar sites. The solar site tool is part of a photovoltaic integrated mitigation program for assessment of climate, topography, and soils (“PV-IMPACTS”). The solar site tool is a geospatial tool that represents the solar industry's first comprehensive, predictive erosion risk, and environmental benefits screening tool. Using different (for example, twelve) geospatial risk and opportunity data layers, the solar site tool remotely assesses different (for example, fifteen or more) soil erosion, regulatory, and interrelated environmental risk factors on both existing and planned utility-scale solar sites. The solar site tool helps utilities, large-scale solar developers, EPCs (engineering, procurement, and construction), stormwater consultants, and additional utility-scale solar stakeholders understand project-specific risks and opportunities like never before, including design tradeoffs between brownfield and greenfield land acquisition. The solar site tool is designed to help interested parties quickly understand local erosion risk factors and the potential benefits of specific risk mitigation strategies.

The solar site tool includes a map-based visual interface that spotlights potential soil erosion risk factors from the earliest stages of project development to PTO and beyond. The solar site tool models multiple risk factors and screens and calculates the potential for positive economic and environmental opportunities. The solar site tool helps promote proactive, holistic soil health, and vegetation management practices, including pollinator-friendly native seed mixes, which are desirable for solar sites. These strategies are desirable as they are proven to help solar developers address environmental impact assessment (EIA), permitting, and community buy-in requirements on a diverse range of brownfield and greenfield projects. Paired with a knowledgeable erosion control and vegetation establishment service provider, the solar site tool flags early action opportunities to protect nearby waterways, farmland, and other natural capital. With a customized solution involving the application to a solar site of erosion control and soil health control products that are best suited for minimizing the risks of the solar site flagged by the solar site tool, solar project partners can reduce risks to zoning approval, permitting, and operations and maintenance (O&M) while improving ancillary benefits such as biodiversity that matter to neighboring landowners. The solar site tool may be used as a complement to, and ahead of, other site-specific design and compliance tools.

The solar site tool is an automated, multilayer geospatial analytics tool to predict stormwater runoff and soil erosion risks at any solar site, over the entire project lifecycle, regardless of development stage; from pre-construction land development to PTO. In this way, the solar site tool helps developers and EPCs make informed decisions.

The solar site tool complements existing solar site suitability databases and stormwater design processes. Designed to be used upstream in the project development process, the solar site tool can also be used to assess erosion risk on existing sites to inform remedial erosion control strategies and identify opportunities for additional environmental and economic benefit.

An objective of the solar site tool is to educate and engage developers on how to proactively ensure best-in-class soil health and erosion risk management practices on any utility-scale solar site. The solar site tool may couple thousands of soil tests conducted by a provider of the solar site tool with hundreds of thousands GIS calculations, millions of data points, and predictive data layers from U.S. government agencies including NOAA (National Oceanic and Atmospheric Administration), USDA (United States Department of Agriculture), and USGS (United States Geological Survey).

The solar site tool is operable to identify for each solar site a risk level concerning erosion-related challenges of the land of the solar site based on geographical factors and climatic factors of the solar site and soil health risk and vegetation challenges of the land of the solar site based on soil characteristics of the solar site.

The solar site tool assigns an overall risk score to each solar site. The overall risk score is based on the erosion-related challenges and the soil health risk and vegetation challenges of the land of the solar site. For each solar site, the solar site tool considers erosion risk factors of the solar site and soil health risk factors of the solar site in assigning the overall risk score of the solar site. The erosion risk factors considered by the solar site tool for each solar site include its rainfall erosivity (R-Factor), future rainfall risk (Delta R-factor) (increased risk of extreme precipitation due to climate change not covered by today's design approaches, e.g., RUSLE2), soil textural effects (K-Factor), and slope (% of solar site falling into >5° of slope, for example). The soil health risk factors considered by the solar site tool for each solar site include its pH, soil organic matter (SOM) content, and sodium adsorption ratio (SAR). In further detail of the Delta R-factor, predicted changes in climate can lead to extremes on both ends (i.e., more precipitation vs. less precipitation). That is, an area could be more susceptible to drought (minimal or no precipitation) just as easily as it could be more susceptible to extreme precipitation events. In this way, the Delta-R factor is indicative of the change in risk of extreme precipitation.

The solar site tool is further operable to flag for each solar site information concerning any pollinator, native cover opportunities for adjacent land in proximity to the solar site and any regulatory risk related to state, local regulations for solar and stormwater.

A goal of the solar site tool is to make interested parties including developers and construction partners fully aware of all erosion risks and opportunities so there are no surprises in solar project budgeting, permitting, construction, or operations. To best serve the solar industry and protect the environment, the solar site tool may be made available to interested parties by a service provider having expertise in best management practices (BMPs) for erosion control and expertise in holistic erosion control solutions on utility-scale solar sites.

The solar site tool fills a knowledge gap in the market. The knowledge gap is that despite well-established best practices for site engineering, many solar projects do not address erosion control early enough in the design process. Incomplete soil testing and inadequate budgets coupled with suboptimal stormwater control designs translate into unmitigated erosion risk, sometimes resulting in severe disruptions to site operations, power production, and even legal liability.

It is challenging to establish healthy vegetation on any construction site due to compaction, topsoil removal, and land cover change, but solar sites face specific challenges and yield unique opportunities due to competing uses for land. Brownfield sites have been designated by the EPA as priority candidates for converting contaminated, at-risk land into value-providing sources of clean energy, but they come with unique erosion challenges such as the slope and topography at landfills and mines and soil health risks at superfund sites. Greenfield sites often pose soil health risks based on previous site conditions. Degraded crop land makes a good target for solar sites but brings concerns over soil condition (compaction, nutrient depletion, salt accumulation). Land-use change at greenfield sites is also a trigger for environmental permitting; and local government, state, and other community stakeholders are increasingly concerned with the impact of utility solar construction and operation on wildlife (including fish and game), biodiversity, habitat, and animal corridors.

The solar site tool satisfies a need for a modern tool that predicts erosion-related risks tied to several factors, not just soil type or precipitation, but advanced factors like future changes in precipitation, site topography, and what the land was previously used for before becoming a solar site candidate. As the solar market grows, competition for suitable utility scale solar sites will naturally increase, and developers will increasingly turn to sites with challenging slopes, degraded soils, and adjacent wetlands and waterways.

Typical solar site suitability tools emphasize photovoltaic potential, proximity to an electrical interconnection, and other economic factors, but fail to capture soil health and erosion control factors per the solar site tool. A solar site may be feasible from a basic economic perspective, but could also require extensive stormwater management, erosion control, and soil management (identifiable with the use of the solar site tool) to protect adjacent land uses—including streams, rivers, lakes, farmland, and developed areas.

The solar site tool is a screening tool for use in identifying risks and opportunities related to erosion and soil health at current, in development, and potential solar sites. The solar site tool allows any party involved in utility-scale solar site planning to take early action against potential issues that could result in additional costs, regulatory and permitting issues, and even interrupt future solar power production. In short, the solar site tool allows users to conduct a robust, remote risk and opportunity assessment before ever setting foot on potential new sites and helps determine the next steps for development.

The following Table provides an overview of actions when using the solar site tool in the solar development process:

| | | Service Provider services and |
|---|---|---|
| Phase | What a user can do with the solar site tool | tools |
| Planning and Site | Evaluate a single site or portfolio of sites | Connect with service |
| Acquisition | for erosion related risks in one easy step. | provider experts to review |
| | Flag problematic site conditions that will | site-specific reports, maps, |
| | require smart site planning and enhanced | risk scores, and to get |
| | environmental impact assessment (EIA). | connected to construction |
| | Evaluate risks and opportunities posed | experts. |
| | by surrounding environmental features | Develop early action items |
| | such as wetlands, waterways, protected | and recruit the right project |
| | lands, and agriculture. | partners for effective |
| | | stormwater and vegetation |
| | | management. |
| Financing and | Satisfy investor risk management | Construction partners can |
| Budget | concerns and avoid surprises in due | build accurate budgets for |
| Development | diligence. | major bid packages by |
| | Analyze predictive risk factors including | utilizing service provider |
| | flood and extreme rainfall. | expertise to select the right |
| | | products to address both the |
| | | physical and chemical |
| | | properties of soil and site |
| | | characteristics. |
| Permitting | Quantify the positive impact that | Consult with service |
| | pollinator-friendly native cover will | provider experts on how to |
| | make as part of a comprehensive | cost-effectively mitigate site |
| | stormwater management strategy. | environmental risks related |
| | Save time and money: One single tool | to stormwater management |
| | does the work of 12+ separate | and soil erosion. |
| | government databases and | Construction partners can |
| | environmental data sources. | utilize service provider |
| | | expertise to create erosion |
| | | control and reclamation |
| | | specifications for submittals |
| | | in minutes. |
| Site | Anticipate and mitigate erosion related | Before breaking ground, |
| Improvement, | risks that may occur during construction | request a soil test. |
| Plant | and long after commissioning. | Service provider experts can |
| Construction, | Identify operating sites that may require | connect the user to seed |
| Testing | intervention to avoid production | vendors, erosion control |
| | outages, legal liability, or both. | contractors, and consultants |
| | | for vegetation and |
| | | stormwater management |
| | | plans (VMPs, SMPs). |
| | | Implement service provider |
| | | erosion control solutions, |
| | | such as soil amendments |
| | | and hydraulically applied |
| | | seed in combination with |
| | | vegetation best management |
| | | practices. |

Use of the solar site tool enables the following key outcomes of proactive planning. Choose optimal soil erosion control solutions that enhance community economic and environmental benefits, creating a win-win for developers, municipalities, adjacent landowners, and community members. Protect, preserve, and enhance biodiversity and ecosystem services by planning for holistic soil health and erosion controls strategies from the earliest stages of project development. Save time, money, and avoid disruptions to operations in the future.

Use of the solar site tool can help answer questions that solar developers and project partners should be asking from the very earliest stages of site selection and project development. These questions that can be answered include: How will the solar site project comply with regulations related to stormwater runoff, and proximity to wetlands, regulated water bodies, and protected lands? What can be learned about the soil health and surrounding land uses before even setting foot on the proposed solar site? Are there characteristics about the solar site that should be known about for project budget, site plan, and future business continuity? How does previous land use on the solar site impact construction budget and development plans? Given the unprecedented increase in extreme rainfall in some areas, what is the likelihood that the solar site will be impacted by flooding or excessive runoff in the future? What are solar site developers telling investors about the approach to business continuity risks and environmental hazards, including flooding, extreme rainfall, and soil erosion? How will unanticipated expenses related to establishing vegetation on the solar site, i.e., bringing in hundreds of truckloads of expensive topsoil, be avoided? How will community acceptance be gained and how to prove that the solar site design protects and enhances the value of neighboring lands? Can a value on the economic benefits that will be returned to the neighboring community if pollinator-friendly native cover instead of turfgrass is used for the solar site be quantified?

The solar site tool uses remotely sensed or derived data to flag potential erosion, soil health, and regulatory risks for interested parties including solar site developers. As indicated, the solar site tool is a screening tool which interested parties can use starting at the earliest stages of project development to better understand local erosion risks and opportunities. The solar site tool can also be used by solar site developers of currently operating solar projects to identify major local erosion risk drivers and take action to mitigate risk.

Inputs to the solar site tool for each solar site include soil texture, slope, soil pH, soil organic matter content (i.e., organic matter of the soil converted from a soil organic carbon (SOC) of the soil), sodicity hazard, ground cover, current precipitation, extreme precipitation, and soil erodibility of the solar site. These inputs are stored in a database of the solar site tool. Outputs from the solar site tool for each solar site include flood risk, proximity to wetlands, proximity to impaired waterways, proximity to protected areas, regulatory risk, land-use and conversion risk, erosion risk, and soil health of the solar site. These outputs are also stored in the database of the solar site tool.

Analysis employed by the solar site tool builds upon multiple existing databases and geodata layers and covers two main groups of solar sites in the contiguous U.S.: major solar projects and brownfield solar sites. Information from data sources concerning the solar sites is stored in a database of the solar site tool.

The following Table includes exemplary information regarding same (the acronyms: SEIA stands for the Solar Energy Industries Association; EIA stands for the U.S. Energy Information Administration; and EPA stands for the U.S. Environmental Protection Agency):

| Project | Data | | | Number |
|---|---|---|---|---|
| Type | Source | Class | Definition | Analyzed |
| Major | SEIA | Operating | SEIA-listed projects that are “interconnected and | 1,200 |
| Solar | EIA | | delivering electricity for commercial use” & | |
| Projects | | | “operable electric generating plants” with solar as | |
| | | | a primary energy source, as listed by the EIA. | |
| | | | Filtered to include only projects with nameplate | |
| | | | capacities of 10 MW or greater. | |
| | SEIA | Under | SEIA-listed projects that have received regulatory | 258 |
| | | Construction | approvals and where “substantial site | |
| | | | modification is underway.” Filtered to include | |
| | | | only projects with nameplate capacities of 10 MW | |
| | | | or greater. | |
| | SEIA | Under | SEIA-listed projects determined to be under | 336 |
| | | Development | development based on public information or | |
| | | | private conversations with developers. Filtered to | |
| | | | include only projects with nameplate capacities of | |
| | | | 10 MW or greater. | |
| Brownfield | EPA | Brownfield | Parcels of contaminated or formerly contaminated | 12,129 |
| Sites | | | land (including landfills, mines, brownfields, and | |
| | | | superfund sites) identified by the EPA for | |
| | | | potential renewable energy development. For this | |
| | | | analysis, it is assumed that any of these potential | |
| | | | sites may get built if it is suitable from an | |
| | | | engineering, economic perspective. These sites | |
| | | | may or may not be associated with major solar | |
| | | | projects in the analysis. Filtered to include only | |
| | | | projects with nameplate capacities of 10 MW or | |
| | | | greater. | |

Analysis conducted by the solar site tool spans multiple risk layers and multiple opportunity layers related to erosion risk, control, and prevention at the solar sites. For example, in one implementation, 13,923 current and potential solar project sites were run through the risk and opportunity layers, producing 612,000 cells of GIS analysis.

The following Tables depict information concerning the risk layers and the opportunity layers used in the analysis conducted by the solar site tool for each solar site (the acronyms: NOAD stands for the U.S. National Oceanic and Atmospheric Administration; NLCD stands for the U.S. National Land Cover Database; and GIS stands for geographic information system):

| Risk Layer | Data Inputs (Sources) | Results | |
|---|---|---|---|
| Erosion Risk | R-factor: Rainfall erosivity | Erosion | Erosion Risk |
| Score | (NOAA) | Risk Score: 0-100 | Classification: |
| | K-factor: Soil erodibility (USDA | | Low, Moderate, |
| | SSURGO via ESRI ArcGIS) | | High, Very High |
| | Slope (DEM from ArcGIS Online) | | |
| | Expected change in extreme | | |
| | precipitation (U.S. National | | |
| | Climate Assessment) | | |
| Soil Health | pH: Soil acidity (SSURGO) | Soil Health | Soil Health Risk |
| Risk Score | Organic matter: Soil organic | Risk Score: 0-100 | Classification: |
| | carbon, converted to soil organic | | Low, Moderate, |
| | matter (SSURGO) | | High, Very High |
| | Sodicity hazard: sodium adsorption | | |
| | ratio (SSURGO) | | |

| | | |
|---|---|---|
| Composite | Erosion Risk Score and Soil Health | Composite |
| Risk Score | Risk Score | Risk Score: 0-200 |
| Land Use | Land Cover (NLCD) and | Land-Use Risk Classification: Low, |
| Risk | CropScape (NASS CDL Program) | Moderate, |
| | | High, Very High, Extreme |
| Flood Risk | Flood frequency (SSURGO) | Flood Risk Classification: |
| | | No Risk, Low, Medium, High Risk |
| Wetlands | Wetland Land Cover (NLCD) | Wetlands Risk: |
| Proximity | | Flagged, Not Flagged |
| Waterways | Burdened/Impaired Waterways | Waterways & Impaired Waterways Risk |
| & Impaired | (EPA TMDL & CWA 303(d)) | Classification: No Risk, Low, Medium, |
| Waterways | ATTAINS Program Data (EPA) - | High Risk |
| Proximity | all waterways tracked by EPA | |
| Risk | Data layer also uses: “North | |
| | America Lakes and Rivers” dataset | |
| | from ArcGIS Living Atlas | |
| Protected | Protected Areas (PAD-US) | PAD-US Risk: |
| Areas | | Flagged, Not Flagged |
| Proximity | | |
| State | State Specific Solar Guidelines | Implied State Regulatory Risk for |
| Regulatory | (Custom Research) | Utility Solar: |
| Risk | | Flagged, Not Flagged |

| Opportunity | | |
|---|---|---|
| Layer | Data Inputs (Sources) | Results |
| Maintenance | Methodology (Janke et al. & | Average potential |
| Cost | additional sources) | cost savings per |
| Reduction | | year and over |
| | | project lifetime |
| Pollinator | Methodology (Walston et al. & | Potential Economic |
| Agricultural | additional sources) | Benefit |
| Benefits | Landcover (Cropland Data Layer) | |

### Erosion Risk Score

For each land site, the solar site tool provides an erosion risk score using the erosion risk data layer. The erosion risk data layer consists of a custom-built, erosion risk index powered by four industry-validated factors influencing erosion and stormwater run-off. These erosion risk factors for each site are rainfall erosivity of the site, soil erodibility of the site, slope gradation (or slope) of the site, and the expected change in extreme precipitation of the site due to climate change in a 2° C. warmer world. The expected change in extreme precipitation erosion risk factor is a measure of predicted changes in precipitation patterns of the site due to climate change. The solar site tool stores the obtained erosion risk factor data in its database.

Each erosion risk factor of a solar site captures unique climatic, geographic, and topographic-related contributions to increased erosion risk at the site. The rainfall erosivity (R-factor) and soil erodibility (K-factor) components come from the Revised Universal Soil Loss Equation 2 (RUSLE2). Developed by the USDA, RUSLE2 is an algorithm used by engineers and hydrologists to estimate erosion over time at a specific location. The rainfall erosivity represents the erosivity from specified rainfall return frequencies and intensities for a given area at a specific location. The soil erosivity captures potential erosion at a specific location due to intrinsic soil properties and geographical soil properties.

The solar site tool evaluates slope-related risk (slope factor) based on a weighted evaluation of slopes, for example, above 2°, 5°, and 10°. The expected change in extreme precipitation factor (Delta R-factor) represents the increased erosion risk at a specific location due to heavier rainfall and stronger storms in a +2° C. modeled future climate. The soil erosion risk index implemented by the solar site tool maps the weighted average of these four factors normalized on a scale of 0-100 in raster form (grid-based data format) depicting the spatial distribution of the soil erosion risk.

In one implementation, the erosion risk score for a site is based on the four erosion risk factors (i.e., the K-factor, the R-factor, the Delta R-factor, and the slope factor) for the site with equal weighting (i.e., 0.25) of the erosion risk factors. In other implementations, the weighting may be set differently.

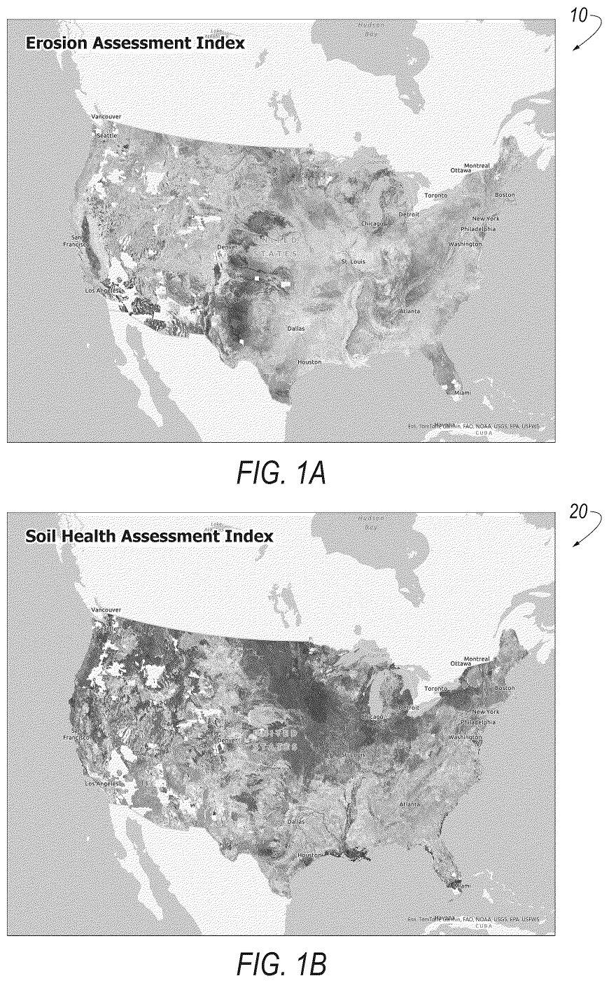

FIG. 1A illustrates a map 10, generatable and displayable by the solar site tool, that is indicative of the erosion risk score at locations across the continental United States.

With the use of the solar site tool, overall conclusions and trends may be understood with an analysis of erosion risk scores for the SEIA/EIA solar sites. For example, the analysis may reveal that the average operating solar project has a certain average erosion risk score, projects under construction having a higher average erosion risk score, and projects under development have an even higher average erosion risk score. As another example, the analysis may reveal from high erosion risk sites and very high erosion risk sites that the K factor is the dominant erosion risk factor for most of these sites, followed by the expected change in extreme precipitation for other sites, followed by the R-factor for other sites, and followed by the slope for the remaining sites. As another example, the analysis may reveal that the slope is the dominant erosion risk factor in certain regions, the R-factor is the dominant erosion risk factor in other regions, and the change in expected precipitation is the dominant erosion risk factor in remaining regions.

With the use of the solar site tool, overall conclusions and trends may be understood with an analysis of erosion risk scores for the brownfield solar sites. For example, the analysis may reveal that almost all of brownfield sites 10 MW or greater are at high risk or very high risk for geophysical-related erosion challenges, compared to only a simple majority of the major solar sites; and that of the brownfield sites in the high or very high-risk bands, most of these sites are on known abandoned mine land or landfills. As another example, the analysis may reveal that for high and very high-risk brownfield sites, that the slope is the dominant erosion risk factor for most of these sites, followed by the K factor for other sites, followed by the expected change in extreme precipitation for other sites, followed by the R-factor for the remaining sites. From this analysis, it is readily apparent that developers need to pay special attention to slope-related erosion risks at brownfield sites, especially given concerns around contaminated stormwater runoff.

Cover management (the C factor) and support practices (the P factor) are not accounted for in the erosion risk index. The cover management factor considers the effect of vegetation and other cover techniques to reduce soil erosion. Examples of cover management include mulching, establishing vegetation, riparian buffers, and more. The support practices factor accounts for the effectiveness of various conservation practices in reducing soil erosion. Examples of support practices include soil preparation, contouring, slope interruption devices, buffer strips, sediment control measures, terraces, concave slopes, and more. The specific support and cover management practices chosen for a site are dependent on the characteristics of the site.

The following Table depicts exemplary information concerning the risk levels of the erosion risk scores:

| Risk Range | Risk Level |
|---|---|
| 0-20 | Low |
| 20-32 | Moderate |
| 32-40 | High |
| 40-100 | Very High |

### Soil Health Risk Score

The soil health data layer consists of a custom-built, soil health risk index powered by three soil health factors: soil pH (i.e., soil acidity or alkalinity), soil organic matter (SOM), and sodicity hazard (i.e., sodium adsorption ratio (SAR)). The solar site tool assesses soil health as soil health is critical to determining erosion risk and thereby determining appropriate erosion control measures and soil amendments. Erosion risk depends on soil health as improved soil health can increase water infiltration and retention, decrease runoff rates, and is critical to establish sustainable vegetation. The solar site tool obtains each soil health factor in this soil health data layer from SSURGO (Soil Survey Geographic Database) in raster form and captures a unique soil chemistry factor indicative of challenging conditions for establishing vegetation. The solar site tool stores the obtained soil health factor data in its database.

In certain implementations, the solar site tool reclassifies the soil acidity (pH) data based on typical USDA nomenclature and assigns risk points between 0 and 100 to the data based on its service provider's soil chemistry experts and experience on-site at challenging projects. In certain implementations, the solar site tool derives the soil organic matter (SOM) data by multiplying soil organic carbon data by a factor of 1.72 and then reclassifies and assigns risk points between 0 and 100 to the data. In certain implementations, the solar site tool similarly reclassifies and assigns risk points to the sodium adsorption ratio (SAR) data. The soil erosion risk index implemented by the solar site tool maps a weighted average of these three factors normalized on a scale of 0-100 in raster form. In one implementation, the soil health risk score for a site is based on the three soil health risk factors for the site with equal weighting (i.e., 0.33) of the soil health risk factors. In other implementations, the weighting may be set differently. A weighted average of the three soil health data factor risk points of a site produces a soil health raster map of the site.

Healthy soil is the foundation to establish vegetation. Depleted soils demonstrating a lack of organic matter, nutrients, or poor texture, may be caused by pre-existing soil conditions or construction practices. Soil acidity or alkalinity (pH) is critical to soil health because it affects seed germination, nutrient availability, plant nutrient uptake, microbial activity, and soil structure. Maintaining an appropriate pH range, such as between 6.3 and 7.3, is essential for promoting healthy plant growth and maximizing nutrient uptake from the soil. Soil organic matter (SOM) refers to the humus present from decomposed remains of plants, animals, and micro-organisms in the soil. SOM is rich in carbon compounds and generally contains essential plant macronutrients of nitrogen, phosphorous, and potassium, as well as micronutrients. Maintaining and increasing organic matter content in soils is important to vegetation establishment as it improves soil structure, enhances water holding capacity, boosts nutrient cycling and contributes to plant disease suppression. Sodium adsorption ratio (SAR) is the measure of the relative concentration of sodium to calcium and magnesium in the soil. Sodium can be detrimental to plant health and soil colloid formation.

The solar site tool provides a crucial initial prediction of soil health on potential or existing solar sites. However, the significant influence of previous land use and environmental management on soil conditions necessitates a more detailed analysis through precise site-specific soil testing.

The soil health is evaluated to create optimal soil conditions. The evaluation includes evaluating the soil fertility (i.e., the soil health score) and providing a basis for amendment recommendations according to the soil health score. In this way, the solutions are “prescriptive” and help ensure appropriate plant species selection for solar sites.

FIG. 1B illustrates a map 20, generatable and displayable by the solar site tool, that is indicative of the soil health risk score at locations across the continental United States.

With the use of the solar site tool, overall conclusions and trends may be understood with an analysis of soil health risk scores for the SEIA/EIA solar sites. For example, the analysis may reveal that the major solar projects that are at high or very high risk for soil health and vegetation management-related challenges and whether these sites are operating sites or are under construction or under development. The analysis may reveal that at major solar projects at high or very high risk, soil health risk is driven for a vast majority of these sites by soil organic matter with the soil health risk for the remaining sites being driven by pH.

The following Table depicts exemplary information concerning the risk levels of the soil health risk scores:

| Risk Range | Risk Level |
|---|---|
| 0-25 | Low |
| 25-53 | Moderate |
| 53-75 | High |
| 75-100 | Very High |

### Composite Risk Score

The composite risk score (i.e., the composite erosion and soil health risk assessment score) is a composite score of the erosion risk score and the soil health risk score. In one implementation, the weighting of the erosion risk score and the soil health risk score in determining the composite risk score is equal (i.e., 0.50). In other implementations, the weighting is different such as favoring the erosion risk score in certain implementations and favoring the soil health risk score in other implementations.

Depending on the composite risk score of a site, the solar site tool may inform a user of the solar site tool with a recommendation that the user conduct site-specific soil testing of the site and utilize on the site advanced erosion control specifications based on remote-geospatial data.

The composite risk score of a site provides a valuable initial assessment of potential erosion and soil health risks for solar developments through remote analysis. However, a more comprehensive evaluation requires consideration of additional factors. In this regard, the solar site tool analyzes more risk factors such as land use risk, flood risk, proximity to protected areas and waterways, and regulatory enforcement. Opportunity considerations focus on the benefits of establishing native plant and pollinator habitats such as maintenance cost reductions and the socioeconomic benefits from increased agricultural productivity.

### Land Use Risk

Previous land-use and cover can be indicative of potential soil health and erosion challenges or necessary enhancement for solar project construction and operation. Powered by land use data from the National Land Cover Database and crop data from CropScape-Cropland Data Layer, the solar site tool analyzes this data layer for potential erosion risk at solar projects by determining the majority land use/landcover condition and classifying the sites under different land use risk categories.

The following Table depicts exemplary information concerning the risk levels of these land use risk categories:

| Land-Use | |
|---|---|
| Risk | Definition of Risk Level |
| Low Risk | No data/out of study bounds/land use is unlikely to introduce additional risk |
| | factors that are not addressed elsewhere in the model. |
| Moderate | Likely to require proactive remediation and erosion BMPs based on prior land use |
| Risk | (e.g., all cropland by default represents a change of use and poses risk) |
| High Risk | Highly likely to require soil health proactive remediation to address compaction, |
| | biochemical properties, and special site considerations associated with past uses. |
| | e.g., brownfields = soil caps and contaminate concerns; certain crops, e.g., |
| | blueberries for pH and nutrient depletion; corn and other monoculture crops nutrient |
| | depletion, pH; tree crops impact soil texture when removed. |
| Very High | Meets ‘High’ criteria, plus additional permitting/regulatory risk related to likelihood |
| Risk | of EIA process, community impact, perceptions of negative land use change. |
| Extreme | Meets ‘Very High’ criteria, plus loss of forest carbon stock; additional reputational |
| Risk | optics risk of ‘deforestation’, loss of biodiversity, increase in surface temperatures, |
| | etc. |

The solar site tool assesses the historical land use data of a site and ranks each type on a scale of zero to five based on how susceptible the site is to erosion and the potential regulatory risk. Sites score a zero when the historic land use does not create additional risk. A score of two or three means the site will likely require some level of soil health remediation and erosion best management practices to reduce risk. A score of four or five puts the site at high regulatory/permitting risk and may have other negative impacts on biodiversity, surrounding communities, or reputational optics.

### Flood Risk

Flooding is a main driver for erosion and stormwater runoff risk. Certain regions of the U.S. are more susceptible to flooding and other extreme weather events. To assess flood risk and potential erosion impacts at major solar sites and brownfields, the solar site tool determines the projected average number of floods over a typical solar project lifetime of thirty years, using SSURGO flood frequency data. The solar site tool intersects the sites with the flood frequency data and assigns flood risk scores based on the majority flood frequency class within the site boundaries and evaluates the number of acres on site within a SSURGO flood frequency class.

The following Table depicts exemplary information concerning the risk levels of the flood risk scores:

| Flood Risk | SSURGO Flood Frequency Class |
|---|---|
| No Risk | None |
| Low Risk | Very Rare (<1% chance in a year) |
| | Rare (1-5% chance per year . . . ) |
| Medium Risk | Occasional (5-50% chance per year) |
| High Risk | Frequent (50%+ per year, <50% chance per month) |
| | Very Frequent (50% chance each month or greater) |

Brownfield developers looking to convert contaminated sites into solar farms need to take proactive measures at sites with flood-related risk, which should be considered along with the impaired waterways and wetlands risk layers. The combination of high flood risk near waterways and wetlands represents increased risk of sediment discharge and runoff, and to reduce the potential impacts of flood risk, developers should consider erosion control methods tailored to the specific risks.

### Wetlands Proximity

Proximity to wetlands represents increased risk for discharging stormwater runoff and soil sediment into sensitive ecosystems, which can negatively impact biodiversity and ecosystem services. Developers building or operating solar projects near wetlands need to be aware of the erosion and stormwater run-off risks related to local topography and climate. Wetlands provide habitat for many different plant and animal species and support ecosystem services including water filtration, carbon sequestration, and recreation. Increased stormwater run-off and erosion into wetlands can negatively impact the sensitive ecosystem and associated biodiversity.

The solar site tool assumes that solar projects which overlap or are within about 200 feet (about 61 m) of NRCS or CropScape provided wetlands area pose a potential risk to those ecosystems. Using this assumption, with the use the solar site tool, overall conclusions and trends may be understood with an analysis of wetland proximity risks for solar sites. For example, the analysis may reveal that about half of major solar projects have a significant wetland proximity risk and about a third of brownfield sites have a significant wetland proximity risk. The analysis may additionally reveal that solar sites that are under development or under construction have a higher percentage of having a significant proximity risk than currently operating sites. This indicates that for in-development or potential new sites, developers will need to pay special attention to wetland guidance and take extra runoff and erosion precautions at the sites to avoid causing environmental harm.

### (Impaired) Waterways Proximity

The Clean Water Act Section 303(d) requires that states submit a list of impaired and threatened waterways that do not meet water quality standards every two years. Once identified, the EPA sets an acceptable TMDL (Total Maximum Daily Load) parameter for each of these polluted waterways. The solar site tool includes proximity to these waterways in the analysis because erosion and run-off from utility scale solar sites could impede compliance efforts and implies that solar project owners and developers will be subjected to greater regulatory scrutiny.

With the use of the solar site tool, overall conclusions and trends may be understood with an analysis of impaired waterway proximity risks for solar sites. In this regard, the solar site tool may analyze the major solar projects and brownfield sites for proximity to these impaired waterways as well as all other lakes and rivers. For example, the analysis may reveal that about half of the major solar projects and about almost all the brownfield sites are at risk due to proximity to impaired and non-impaired waterways. Mitigating erosion and runoff at these sites is of particular importance because contaminants at the site could flow into already impaired waterways—and already under regulatory scrutiny—and cause negative environmental impacts.

The following Table is indicative of exemplary (impaired) waterways risk scores assigned by the solar site tool to solar sites:

(Impaired) Waterways Risk Overlay

| | |
|---|---|
| High Risk | <61 m away from TMDL or 303(d) EPA Impaired Waterways |
| Medium | 61-200 m away from TMDL or 303d EPA impaired |
| Risk | waterways; or <61 m from other EPA Impaired Waterways; |
| | or <61 m away from all other NA Rivers and Lakes |
| Low Risk | 61-500 m away from NA Rivers and Lakes |
| No Risk | Does not meet any of the above criteria |

### Protected Areas Proximity

U.S. terrestrial and marine protected areas (Protected Areas Database of the U.S. (PAD-US)) act as important conservation and research sites for protecting biodiversity and ecosystem services. Renewable energy infrastructure can have environmental impacts on a zone of influence much larger than just the site itself, therefore the risk of building solar sites near protected areas should be considered to preserve biodiversity.

For this analysis by the solar site tool, the solar site tool flags major solar sites and brownfield sites if any part of the site is within 100 m of a designated protected area. The analysis may reveal that 20% of all brownfields and major solar sites (across all phases of development) face risks related to proximity to protected areas.

Project developers with sites near PAD-US areas should consider hydraulically applied erosion control products as a strategy for mitigating additional risk. Such erosion control products include Flexterra® High Performance-Flexible Growth Medium® (HP-FGM®); ProMatrix Engineered Fiber Matrix® (EFM®); and ProGanics DUAL, which are available from Profile Solutions. Of course, these erosion control products may be considered for all sites irrespective of the presence of any PAD-US area.

### Additional State Regulatory Risk

Developers in states with utility-solar specific stormwater guidance (and other voluntary rules) should consider implementing stronger erosion control measures to mitigate the greater implied regulatory risk. As of March 2024, twelve states have stormwater run-off guidance specifically written for utility solar projects. Developers in these states need to understand whether photovoltaic panels are treated as pervious or impervious surfaces in stormwater design regulation. Six states have published guidance for utility-solar developers to follow that mention best practices for designing sites to mitigate risk for fish, game, and wildlife. Twelve states have guidance on specifying native & pollinator-promoting plants on-site. Developers in these states are advised by the solar site tool to consider the use of hydraulically applied erosion control products as a strategy for complying with the various guidance of the states.

### Opportunity Analysis for Erosion Control and Vegetation Management

Direct operation and maintenance (O&M) savings with native plants: Planting native vegetation at solar sites can lead to savings from reduced maintenance costs in comparison to turf grasses and other high maintenance species. EPCs are increasingly specifying native plants as an alternative to conventional turf grass in landscaping projects ranging from college and corporate campuses to residential projects to utility scale solar. One such benefit includes significant operations and maintenance savings over the short and long-term. While native seed mixes may have higher upfront costs, with the savings from reduced mowing and maintenance once established, costs can be recovered within as little as three years depending on the cost and diversity level of the seed mix. The importance of specifying and implementing erosion control and custom seed mixes for permanent stabilization on construction sites is often overlooked. The solar site tool remedies this need by providing a recommendation tailored to the specific needs of a solar site. The recommendation emphasizing the need for proper seeding selection, accurate seeding rates, proper application methods, and the involvement of professional restoration ecologists to achieve successful revegetation efforts and ecological benefits.

Native plants are an especially important consideration for in-development sites to be able to evaluate the current conditions of the site and prepare it for native planting after solar construction. Prior land use conditions, presence of invasive species, soil conditions, and panel height can all have an impact on the establishment of native species and are considered by the solar site tool in planning. Use of the solar site tool by project developers facilitates the project developers in thinking about optimizing seed selection starting at the earliest stages of project development.

Positive Impact on Farmers and Local Communities through Pollinator-Promoting Natives: Another recognized, direct benefit of planting native species involves the positive impact on local pollinator abundance. Cultivating biodiverse, native plant species translates into increases in habit and food availability for native pollinators, which in turn supports the growth of pollinator populations. When pollinator populations increase, so does the total economic value of the ecosystem services they provide. Pollinator activity contributes positive value to human life by supporting biodiversity, by providing aesthetic value to local communities (especially through the pollination of flowering plants that are socially desirable), and by providing direct pollination services to pollinator-dependent agriculture, which benefits farmers, local communities, and all who cat and buy their crops. There is a significant socioeconomic benefit that could be realized by specifying native plant species at utility solar sites across the U.S.

To calculate the total potential gains from agricultural productivity increases if pollinator-promoting native plants were specified at all major solar projects, the solar site tool considers 1.5 km buffer around each solar site and merges these polygons into a single layer. The solar site tool intersects this layer with a Crop Data Layer from Cropscape to calculate the amount of known pollinator-dependent cropland near major solar sites. The solar site tool uses USDA commodities data and assumptions regarding potential annual productivity increases to calculate the total potential economic benefit from pollinators at major solar projects.

Analysis with the use of the solar site tool may reveal that pollinator-dependent agriculture within 1.5 km of all major solar projects could see aggregated yield increases totaling $64,000,000 per year. Each solar project specifying native plants, on average, generates roughly $36,000 per year of social benefit to their neighbors and surrounding community. This translates into an average of over $1,000,000 of social benefit from pollinators per project over the course of a thirty-year project lifetime.

Additional ROI from Native Plants: Additional analysis with the use of the solar site tool indicates potential benefits to photovoltaic performance from specifying native plants for utility solar projects. First, native plants can provide a local cooling effect that increases panel efficiency. The literature, though not fully established, suggests that this benefit is highly dependent on climate zone and typical temperature. Second, photovoltaic panels in arid areas with little vegetation can accumulate dust, which leads to efficiency and performance losses. Native vegetation can be planted for positive impact by decreasing dust and saving money on cleaning.

As described, the solar site tool is useable as an early warning screening tool for a robust group of erosion, soil health, and regulatory-related risks and opportunities. Developers should, however, conduct a robust, full-service risk assessment (including soil testing) and environmental impact assessment. The solar site tool may be further enhanced to consider additional risk factors such as proximity of solar projects to densely populated areas or relative density of existing solar in surrounding areas, both of which can be indicators of community-related risk. The solar site tool may be further enhanced to incorporate additional risk and opportunity layers to provide a comprehensive techno-economic accounting of all environmental, social, operations, and maintenance related benefits related to developing solar projects and specifying native plants vs. alternative solutions. In this regard, the solar site tool may be further enhanced to calculate the net embodied carbon and sequestration benefits of developing solar with native plants vs. turfgrass and impact on soil organic matter over time.

The following exemplary Tables are indicative of the types of risks and opportunities identified by the solar site tool in analyzing the various information concerning the solar sites.

Types of Risks Assessed in Analysis by Project Class

| | | | | | Impaired | | | Protected | |
|---|---|---|---|---|---|---|---|---|---|
| | | Soil | Flood | Wetlands | Waterways | | | Land | State |
| | Erosion | Health | Freq. | Prox. | Proximity | Land- | Land- | Proximity | Reg. |
| | Risk | Risk | Risk | Risk | Risk | Use 1 | Use 2 | Risk | Risk |
| Operating | Yes | Yes | Yes | Yes | Yes | Yes | No | Yes | Yes |
| Under | Yes | Yes | Yes | Yes | Yes | No | Yes | Yes | Yes |
| Construction | | | | | | | | | |
| Under | Yes | Yes | Yes | Yes | Yes | No | Yes | Yes | Yes |
| Development | | | | | | | | | |
| EPA RE- | Yes | No | Yes | Yes | Yes | No | No | Yes | No |
| Powering | | | | | | | | | |
| Potential: | Yes | Yes | Yes | Yes | Yes | No | Yes | Yes | Yes |
| Custom | | | | | | | | | |

Types of Opportunities Assessed in Analysis by Project Class

| | | Pollinator | Beyond Compliance State |
|---|---|---|---|
| | Maintenance | Social | Guidelines on Pollinators, |
| | Cost Savings | Benefits | FWG, Landfill, etc. |
| EIA & SEIA | Yes | Yes | Yes |
| Operating | | | |
| SEIA Under | Yes | Yes | Yes |
| Construction | | | |
| SEIA Under | Yes | Yes | Yes |
| Development | | | |
| EPA RE- | No | No | Yes |
| Power | | | |

The following exemplary Tables are indicative of the risk layers classifications assigned by the solar site tool to the solar sites.

| USDA Soil pH | | Risk |
|---|---|---|
| Classification | pH Range | Points |
| Ultra acidic | 0 to 3.5 | 100 |
| Extremely acidic | 3.5 to 4.4 | 90 |
| Very strongly acidic | 4.4 to 5.0 | 70 |
| Strongly acidic | 5.0 to 5.5 | 50 |
| Moderately acidic | 5.5 to 6.0 | 20 |
| Slightly acidic | 6.0 to 6.5 | 10 |
| Neutral | 6.5 to 7.3 | 0 |
| Slightly alkaline | 7.3 to 7.8 | 20 |
| Moderately alkaline | 7.8 to 8.4 | 50 |
| Strongly alkaline | 8.4 to 9.0 | 90 |
| Very strongly alkaline | 9.0 to 14.0 | 100 |

| SAR Range | Risk Points |
|---|---|
| 0 to 5 | 20 |
| 5 to 9 | 50 |
| 9 to 13 | 80 |
| Greater than 13 | 100 |

| % SOM Range | Risk Points |
|---|---|
| 0.00% to 0.74% | 100 |
| 0.74% to 1.49% | 80 |
| 1.49% to 2.00% | 50 |
| 2.00% to 5.00% | 20 |
| Greater than 5.00% | 0 |

The following exemplary Tables are further indicative of the risk layers identified by the solar site tool for the solar sites.

| Land-Use Risk | |
|---|---|
| at Existing | |
| Solar Sites | Land Types |
| Low Risk | Open Water |
| Moderate Risk | Barren, Developed, Nonag/Undefined, Developed/Open |
| | Space, Developed/Low Intensity, Developed/Med |
| | Intensity, Developed/High Intensity, Shrubland, |
| | Grass/Pasture |
| Very High Risk | Deciduous Forest, Evergreen Forest, Mixed Forest, |

| Land-Use Risk at | |
|---|---|
| In-Development or | |
| Potential Solar | |
| Sites | Land Types |
| Low Risk | Sod/Grass Seed, Water, Open Water, Perennial Ice/Snow |
| Moderate Risk | Mint, Barley, Durum Wheat, Spring Wheat, Winter Wheat, Dbl Crop |
| | WinWht/Soybeans, Oats |
| | Millet, Speltz, Canola, Flaxseed, Safflower, Rape Seed, Mustard, Alfalfa, |
| | Camelina, Buckwheat, Sugarbeets, Dry Beans, Potatoes, Other Crops, |
| | Sugarcane, Sweet Potatoes, Misc Vegs & Fruits, Watermelons, Onions, |
| | Cucumbers, Chick Peas, Lentils, Peas, Tomatoes, Caneberries, Herbs, |
| | Triticale, Carrots, Asparagus, Garlic, Cantaloupes, Prunes, Olives, Oranges, |
| | Honeydew Melons, Broccoli, Avocado, Peppers, Greens, Strawberries, |
| | Squash, Apricots, Dbl Crop WinWht/Corn, Dbl Crop Oats/Corn, Lettuce, |
| | Dbl Crop Triticale/Corn, Pumpkins, Dbl Crop Lettuce/Durum Wht, Dbl Crop |
| | Lettuce/Cantaloupe, Dbl Crop Lettuce/Cotton, Dbl Crop Lettuce/Barley, Dbl |
| | Crop Durum Wht/Sorghum, Dbl Crop Barley/Sorghum, Dbl Crop |
| | WinWht/Sorghum, Dbl Crop Barley/Corn, Dbl Crop WinWht/Cotton, Dbl |
| | Crop Soybeans/Cotton, Dbl Crop Soybeans/Oats, Dbl Crop Corn/Soybeans, |
| | Cabbage, Cauliflower, Celery, Radishes, Turnips, Eggplants, Gourds, Dbl |
| | Crop Barley/Soybeans, Other Hay/Non Alfalfa, Switchgrass, Shrubland, |
| | Clouds/No Data, Developed, Nonag/Undefined, Aquaculture, |
| | Developed/Med Intensity, Developed/High Intensity, Barren (Non- |
| | cultivated), Shrubland, Grass/Pasture |
| High Risk | Corn, Cotton, Rice, Sorghum, Soybeans, Sunflower, Peanuts, Tobacco, |
| | Sweet Corn, Pop or Orn Corn, Other Small Grains, Rye, Hops, Fallow/Idle |
| | Cropland, Cherries, Peaches, Apples, Grapes, Other Tree Crops, Citrus, |
| | Pecans, Almonds, Walnuts, Pears, Pistachios, Pomegranates, Nectarines, |
| | Plums, Developed/Low Intensity |
| Very High Risk | Clover/Wildflowers, Christmas Trees, Vetch, Blueberries, Cranberries, |
| | Developed/Open Space |
| Extreme Risk | Forest, Deciduous Forest, Evergreen Forest, Mixed Forest |

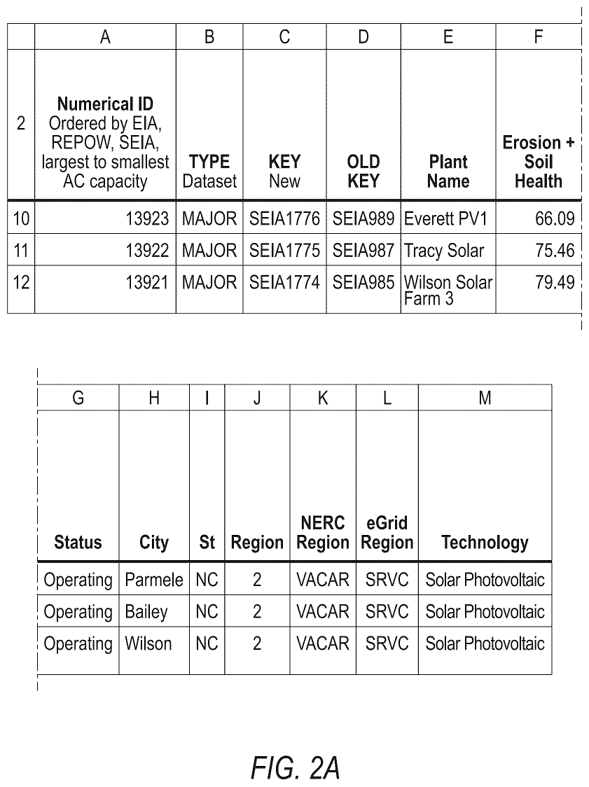

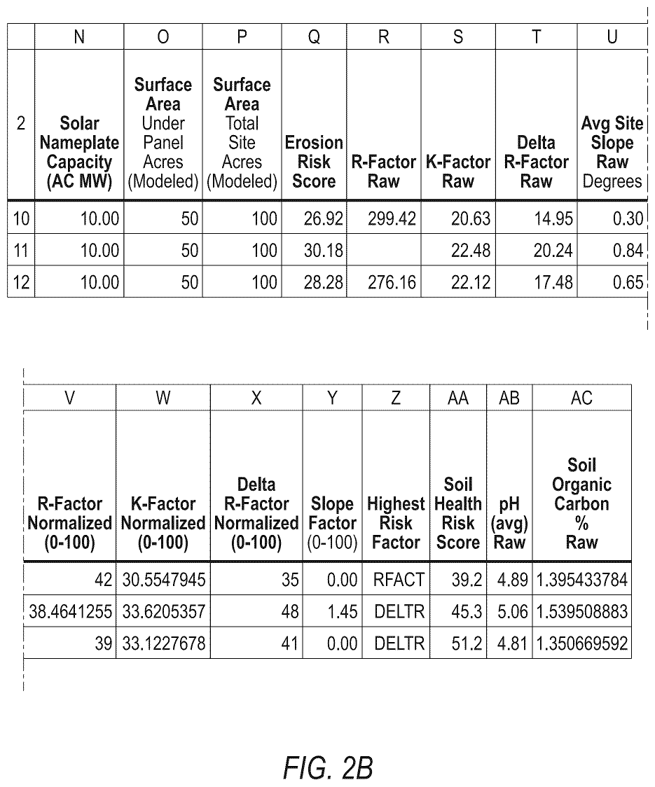

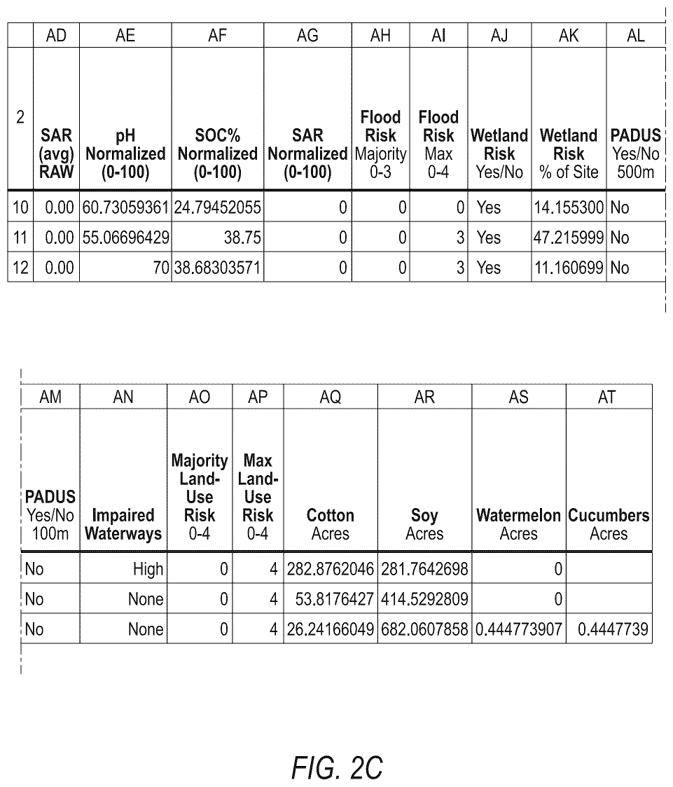

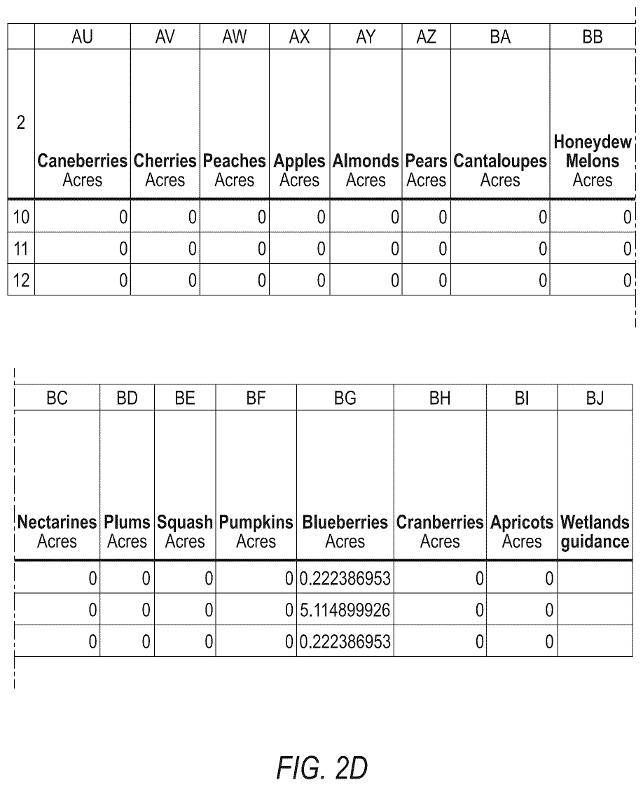

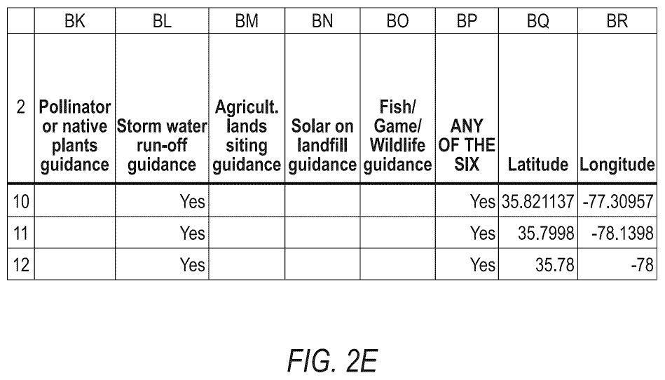

FIGS. 2A, 2B, 2C, 2D, and 2E are a set of exemplary illustrations depicting the various data for the sites, as explained above, that is stored in the database of the solar site tool. For ease of understanding, a table format is shown in these illustrations. The sites are listed in the rows of the table format. The columns of the table format pertain to the data types. Each illustration includes three rows for the same three sites.

As illustrated in the illustrations of FIGS. 2A, 2B, 2C, 2D, and 2E, the data types include the “Erosion+Soil Health” overall risk score, the “Erosion Risk Score” and its four (raw and normalized) erosion risk subfactors, the “Soil Health Risk Score” and its three (raw and normalized) soil health risk subfactors, the flood risk score, information concerning proximity to wetlands, protected areas, and impaired waterways, information concerning the type (e.g., cotton, soy, watermelons, cucumbers, almonds, pears, cherries, peaches, apples, plums, and the like) and the amount (in acreage) of pollinator-dependent cropland in the proximity (e.g., 1.5 kM) within the sites, and geographic location information. Other data types that may be further included include mailing address information, status, MW nameplate capacity, and various other types of information.

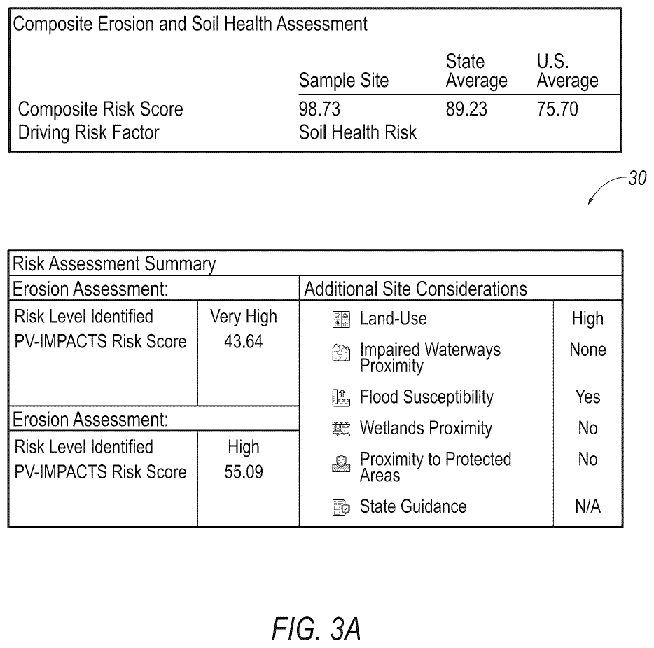

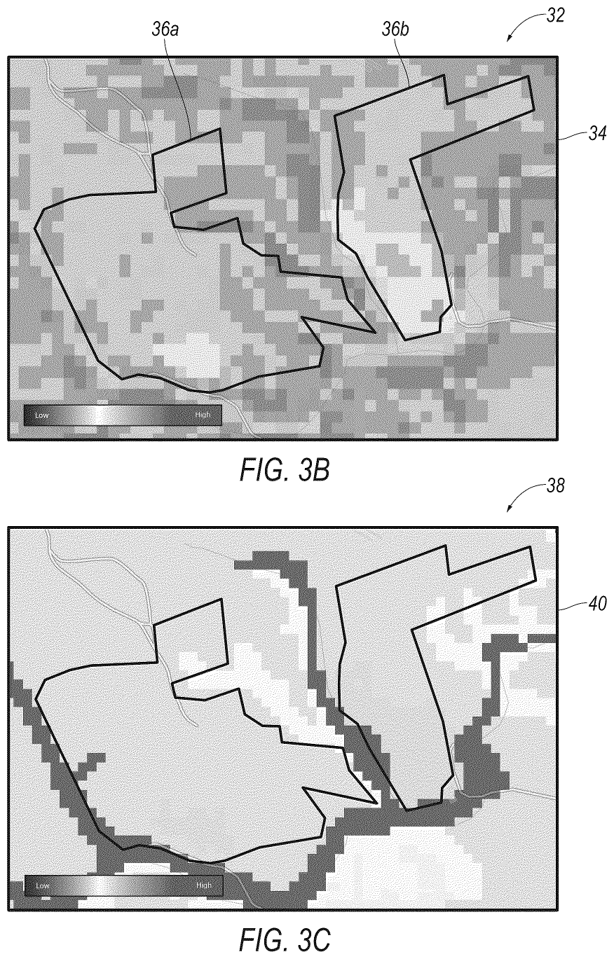

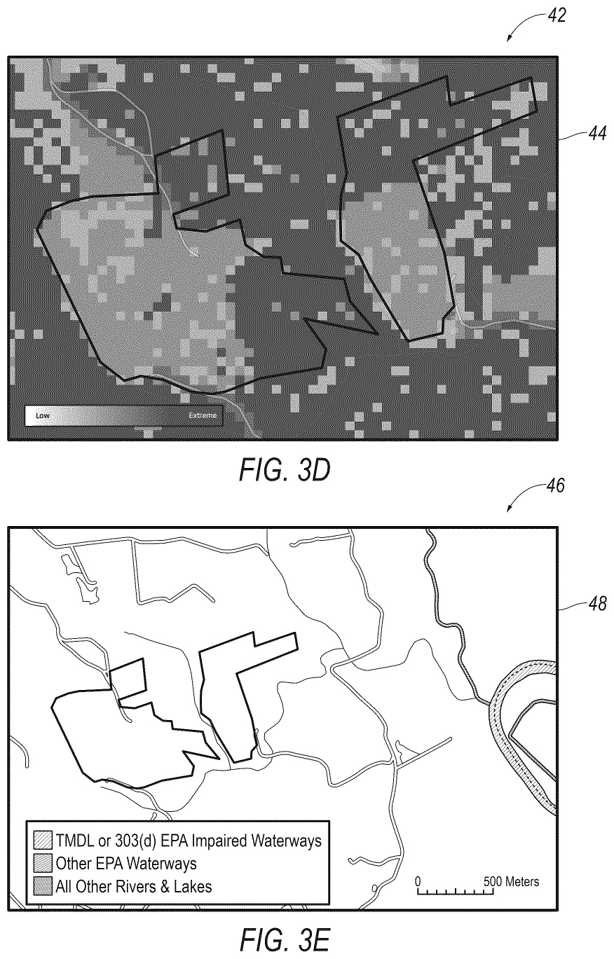

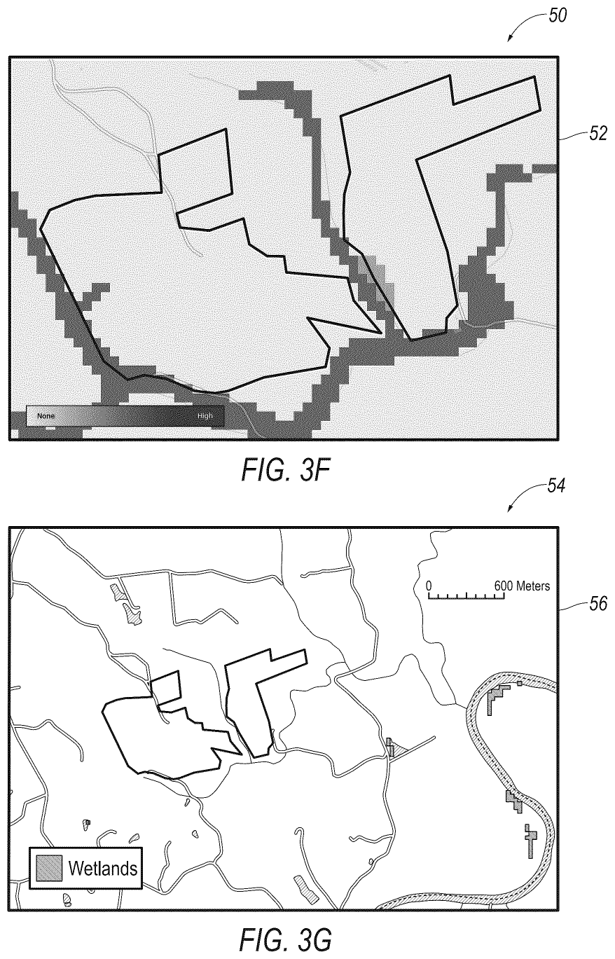

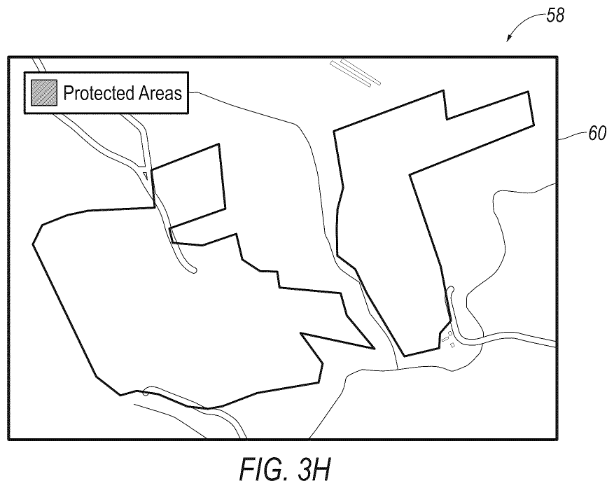

FIGS. 3A, 3B, 3C, 3D, 3E, 3F, 3G, and 3H are a set of exemplary illustrations depicting site report segments of an individual site report provided by the solar site tool to a user requesting risk assessment information concerning a site.

Site report segment 30 of FIG. 3A indicates the composite risk score of the site. Site report segment 30 further indicates the erosion risk score and the soil health risk score of the site, along with an indication of the associated risk levels. Site report segment 30 further indicates the risk/presence of additional site considerations including land-use, impaired waterways proximity risk, flood susceptibility, wetlands proximity, proximity to protected areas, and state guidance.

Site report segment 32 of FIG. 3B includes a map 34 indicative of the erosion risk scores at land points across the site. The erosion risk scores are color coded with red colors being associated with higher risk scores and green colors being associated with lower risk scores. For this exemplary site, the maps of the site report including map 34 have two outlines 36a and 36b which are indicative of solar site infrastructure at the site.

Site report segment 38 of FIG. 3C includes a map 40 indicative of the soil health risk scores at land points across the site. The soil health risk scores are color coded with red colors being associated with higher risk scores and green colors being associated with lower risk scores.

Site report segment 42 of FIG. 3D includes a map 44 indicative of land use risk levels at land points across the site. The land use risk levels are color coded with darker colors being associated with higher risk levels and lighter colors being associated with lower risk levels.

Site report segment 46 of FIG. 3E includes a map 48 indicative of proximity to impaired waterway risk at land points across the site. In this example, there are no impaired waterways in proximity to the site.

Site report segment 50 of FIG. 3F includes a map 52 indicative of flood potential risk levels at land points across the site. The flood potential risk levels are color coded with darker colors being associated with higher risk levels and lighter colors being associated with lower risk levels.

Site report segment 54 of FIG. 3G includes a map 56 indicative of proximity to wetlands risk at land points across the site. In this example, there are no wetlands in proximity to the site.

Site report segment 58 of FIG. 3H includes a map 60 indicative of proximity to protected areas at land points across the site. In this example, there are no protected areas in proximity to the site.

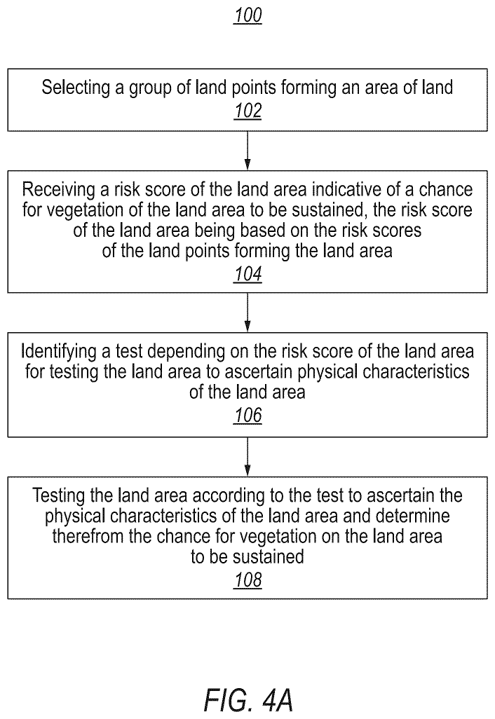

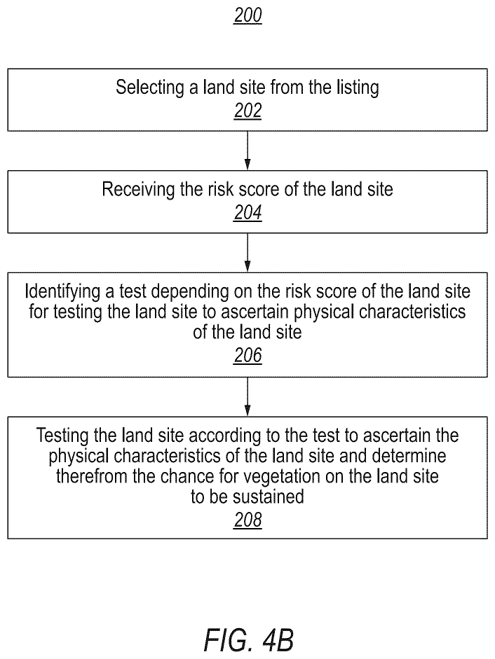

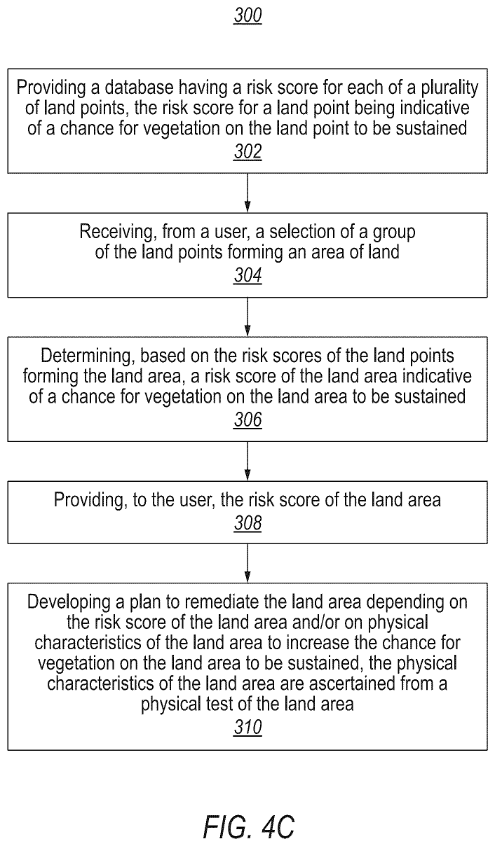

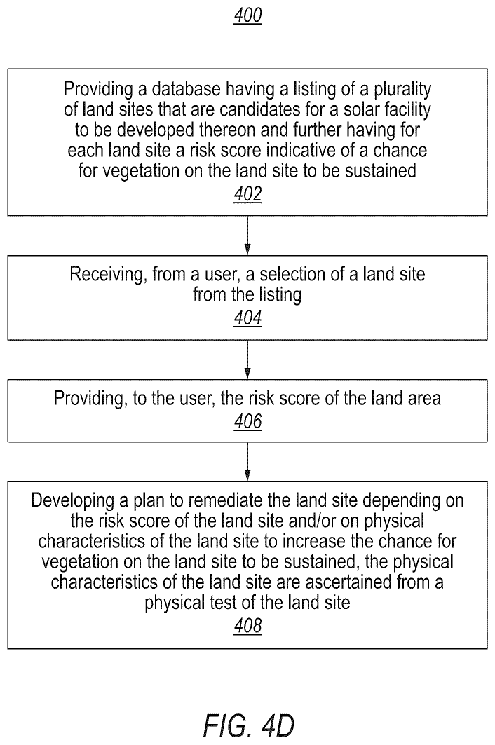

Referring now to FIG. 4A, a flowchart 100 depicting operation of a user when using the solar site tool for an arbitrary land area is shown. As indicated, the solar site tool includes a database having a risk score for each of a plurality of land points with the risk score for a land point being indicative of a chance for vegetation on the land point to be sustained. The operation commences with the user selecting a group of land points forming an area of land, as indicated by process block 102. In response to the user making the selection, the user receives from the solar site tool a risk score of the land area that is indicative of a chance for vegetation on the land area to be sustained, as indicated by process block 104. The solar site tool determines the risk score of the land area based on the risk scores of the land points forming the land area, as further indicated by process block 104. Following receipt of the risk score of the land area, the user and/or a provider of the solar site tool identifies a test depending on the risk score of the land area for testing the land area to ascertain physical characteristics of the land area, as indicated by process block 106. The land area is then tested, such as with the authority of and/or by the user and/or the provider, according to the test to ascertain the physical characteristics of the land area and determine therefrom the chance for vegetation on the land area to be sustained, as indicated by process block 108.

Referring now to FIG. 4B, a flowchart 200 depicting operation of a user when using the solar site tool for a solar site from a listing of solar sites is shown. As indicated, the solar site tool includes a database having a listing of land sites that are candidates for a solar facility to be developed on land thereof and having for each land site a risk score that is indicative of a chance for vegetation on the land site to be sustained. The operation commences with the user selecting a land site from the listing, as indicated by process block 202. In response to the user making the selection, the user receives from the solar site tool the risk score of the land site, as indicated by process block 204. Following the receipt of the risk score of the land site, the user and/or a provider of the solar site tool identifies a test depending on the risk score of the land site for testing the land site to ascertain physical characteristics of the land site, as indicated by process block 206. The land site is then tested, such as with the authority of and/or by the user and/or the provider, according to the test to ascertain the physical characteristics of the land site and determine therefrom the chance for vegetation on the land site to be sustained, as indicated by process block 208.

Referring now to FIG. 4C, a flowchart 300 depicting operation of a provider associated with the solar site tool when a user uses the solar site tool for an arbitrary land area is shown. The provider initially provides the solar site tool with a database having a risk score for each of a plurality of land points, as indicated by process block 302. The operation commences with the provider receiving from the user a selection of a group of the land points forming an area of land, as indicated by process block 304. In response to the selection, the provider determines, based on the risk scores of the land points forming the land area, a risk score of the land area indicative of a chance for vegetation on the land area to be sustained, as indicated by process block 306, and provides to the user the risk score of the land area, as indicated by process block 308. The provider then develops a plan to remediate the land area depending on the risk score of the land area and/or on physical characteristics of the land area to increase the chance for vegetation on the land area to be sustained, as indicated by process block 310. The physical characteristics of the land area are ascertained from a physical test of the land area, as further indicated by process block 310.

Referring now to FIG. 4D, a flowchart 400 depicting operation of a provider associated with the solar site tool when a user uses the solar site tool for a solar site from a listing of solar sites is shown. The provider initially provides the solar site tool with a database having a listing of land sites that are candidates for a solar facility to be developed thereon and further having for each land site a risk score that is indicative of a chance for vegetation on the land site to be sustained, as indicated by process block 402. The operation commences with the provider receiving from the user a selection of a land site from the listing, as indicated by process block 404. In response to the selection, the provider provides to the user the risk score of the land site, as indicated by process block 406. The provider then develops a plan to remediate the land site depending on the risk score of the land site and/or on physical characteristics of the land site to increase the chance for vegetation on the land site to be sustained, as indicated by process block 408. The physical characteristics of the land site are ascertained from a physical test of the land area, as further indicated by process block 408.

As described, in implementations, the solar site tool identifies solar panel installation sites by retrieving information from public, and perhaps private, data sources, identifying risk factors of the sites from the information, making suggestions on how to modify the sites to mitigate the risk factors, and facilitating modification of the sites according to the suggestions. The solar site tool thus automates remote site analysis and raises awareness for site-specific risks and opportunities for advanced control erosion solutions.

As described, the solar site tool employs a predictive approach (i.e., identifying the risk factors) and a prescriptive approach (i.e., providing the suggestions tailored to the risk factors). The suggestions (i.e., recommendation) for a site are tailored to the risk factors in the sense that the suggestions pertain to the “right sized” services and applications for erosion control and vegetation restoration on the site.

The end goal of the predictive and prescriptive approaches is to get vegetation up on a site quickly and correctly.

In various implementations, as described, the solar site tool employs a study methodology and a technological component. The study methodology ingests various open-source geospatial data layers. The technological component employs calculations which use GIS overlay analysis to create a site-specific risk and opportunity score (e.g., a compound risk/opportunity score) that represents the suitability for value-added erosion control solutions on utility scale solar sites. The study methodology documents data sources, calculation methodologies, and high-level conclusions relevant to solar developers and EPCs. The technological component enables the repeating of the scoring analysis of sites and the generation of custom reports of sites for interested parties including developers, EPCs, and engineers associated with the sites.

In various implementations, the solar site tool can be trained and iterate on the risk factors and scoring by comparing outputs of the remote analysis to actual site conditions.

In various implementations, the solar site tool, using multiple geospatial data layers, remotely assesses erosion, soil health, regulatory, and interrelated environmental inputs on both existing and planned utility-scale solar sites. As a geospatial resource, the solar site tool empowers stakeholders like utilities, large scale-developers, consultants, and engineering procurement contractors to proactively address potential site issues. The solar site tool facilitates planning for erosion control, stormwater management, and vegetation best management practices by employing project partners with project-specific insights into risks and opportunities, including design tradeoffs between brownfield and greenfield land acquisition. By identifying potential issues early, stakeholders can make more informed decisions to reduce liabilities related to zoning, permitting, compliance, close outs, and notices of termination as well as ongoing operation and management while improving ancillary benefits, such as biodiversity, and fostering positive relationships with neighboring communities.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A method for use with a database having a risk score for each of a plurality of land points, the risk score for a land point being indicative of a chance for vegetation on the land point to be sustained, the method comprising:
selecting a group of land points forming an area of land;
receiving a risk score of the land area indicative of a chance for vegetation on the land area to be sustained, the risk score of the land area being based on the risk scores of the land points forming the land area;
identifying a test depending on the risk score of the land area for testing the land area to ascertain physical characteristics of the land area; and
testing the land area according to the test to ascertain the physical characteristics of the land area and determine therefrom the chance for vegetation on the land area to be sustained.

2. The method of claim 1 further comprising:
receiving a recommendation, depending on the risk score of the land area and/or on the physical characteristics of the land area, indicative on how to remediate the land area to increase the chance for vegetation on the land area to be sustained; and
remediating the land area according to the recommendation.

3. The method of claim 1 wherein:
receiving a risk score of the land area includes receiving a risk score of a first portion of the land area based on the risk scores of the land points forming the first portion of the land area and receiving a risk score of a second portion of the land area based on the risk scores of the land points forming the second portion of the land area;
identifying a test includes identifying a first test depending on the risk score of the first portion of the land area and identifying a different second test depending on the risk score of the second portion of the land area;
testing the land area includes testing the first portion of the land area in a first manner according to the first test and testing the second portion of the land area in a second manner according to the different second test; and
determining from the physical characteristics of the land area includes determining from physical characteristics of the first portion of the land area ascertained from the testing of the first portion of the land area the chance for vegetation on the first portion of the land area to be sustained and determining from physical characteristics of the second portion of the land area ascertained from the testing of the second portion of the land area the chance for vegetation on the second portion of the land area to be sustained.

4. The method of claim 3 further comprising:
receiving a recommendation, depending on the risk scores of the first and second portions of the land area and/or on the physical characteristics of the first and second portions of the land area, indicative on how to remediate the first and second portions of the land area to increase the chance for vegetation on the first and second portions of the land area to be sustained; and
remediating at least one of the first and second portions of the land area according to the recommendation.

5. A method for use with a database having a listing of land sites that are candidates for a solar facility to be developed on land thereof, the database further having for each land site a risk score that is indicative of a chance for vegetation on the land site to be sustained, the method comprising:
selecting a land site from the listing;
receiving the risk score of the land site;
identifying a test depending on the risk score of the land site for testing the land site to ascertain physical characteristics of the land site; and
testing the land site according to the test to ascertain the physical characteristics of the land site and determine therefrom the chance for vegetation on the land site to be sustained.

6. The method of claim 5 further comprising:
receiving a recommendation, depending on the risk score of the land site and/or on the physical characteristics of the land site, indicative on how to remediate the land site to increase the chance for vegetation on the land site to be sustained; and
remediating the land site according to the recommendation.

7. The method of claim 6 wherein the database further has for each land site (i) an erosion score that is indicative of a degree of erosion expected for soil of the land site and (ii) a soil health score that is indicative of a health of the soil of the land site, and the risk score of the land site is a compound score of the erosion score and the soil health score, wherein the recommendation is further indicative on how to remediate the land site to lessen the degree of erosion expected for the soil of the land site and improve the health of the soil of the land site to increase the chance for vegetation on the land site to be sustained.

8. The method of claim 6 wherein the database further has for each land site an indication of an amount and a type of pollinator-dependent cropland within a given proximity of the land site, wherein the recommendation is further indicative on how to remediate the land site, in a manner consistent with the chance for vegetation on the land site to be sustained being increased, depending on the amount and the type of the pollinator-dependent cropland to increase pollination activities originating from the land site onto the pollinator-dependent cropland.

9. A method for facilitating usage of land, the method comprising:
providing a database having a risk score for each of a plurality of land points, the risk score for a land point being indicative of a chance for vegetation on the land point to be sustained;
receiving, from a user, a selection of a group of the land points forming an area of land;
determining, based on the risk scores of the land points forming the land area, a risk score of the land area indicative of a chance for vegetation on the land area to be sustained;
providing, to the user, the risk score of the land area; and
developing a plan to remediate the land area depending on the risk score of the land area and/or on physical characteristics of the land area to increase the chance for vegetation on the land area to be sustained, wherein the physical characteristics of the land area are ascertained from a physical test of the land area.

10. The method of claim 9 wherein:
developing a plan to remediate the land area includes providing to the user a recommendation, depending on the risk score of the land area and/or on the physical characteristics of the land area, indicative of one or more products which when applied to the land area will increase the chance for vegetation on the land area to be sustained; and
applying to the land area the one or more products according to the recommendation.

11. A method for facilitating usage of land sites as solar facilities, the method comprising:
providing a database having a listing of land sites that are candidates for a solar facility to be developed thereon and further having for each land site a risk score that is indicative of a chance for vegetation on the land site to be sustained;
receiving, from a user, a selection of a land site from the listing;
providing, to the user, the risk score of the land site; and
developing a plan to remediate the land site depending on the risk score of the land site and/or on physical characteristics of the land site to increase the chance for vegetation on the land site to be sustained, wherein the physical characteristics of the land site are ascertained from a physical test of the land site.

12. The method of claim 11 wherein:
developing a plan to remediate the land site includes providing to the user a recommendation, depending on the risk score of the land site and/or on the physical characteristics of the land site, indicative of one or more products which when applied to the land site will increase the chance for vegetation on the land site to be sustained, the one or more products including at least one product for controlling erosion and/or at least one product for controlling soil health; and
applying to the land site the one or more products according to the recommendation.

13. The method of claim 12 wherein:
the one or more products includes the at least one product for controlling erosion, the at least one product for controlling erosion includes at least one of a hydraulically applied erosion control product, a straw mulch, a hydraulic mulch, a bonded fiber matrix, an engineered fiber matrix, an erosion control blanket, a flexible growth medium, and a turf reinforcement mat.

14. The method of claim 12 wherein:
the one or more products includes the at least one product for controlling soil health, the at least one product for controlling soil health includes at least one of a fertilizer, a soil neutralizer, an organic matter, a growth stimulator, an inoculant, and a biotic soil medium.

15. The method of claim 12 wherein:
the one or more products further includes at least one seed product that is a source of the vegetation.

16. The method of claim 12 wherein:
the database further has for each land site an erosion score that is indicative of a degree of erosion expected for soil of the land site, and the risk score of the land site depends on the erosion score of the land site; and
the one or more products includes at least erosion control product which when applied to the land site will lessen the degree of erosion expected for the soil of the land site to increase the chance for vegetation on the land site to be sustained.

17. The method of claim 16 wherein:
the database further has for each land site a plurality of erosion factors, the erosion score for each land site depending on the erosion factors of the land site, and the erosion factors for each land site include a rainfall erosivity of the land site, a soil erodibility of the land site, a slope of the land site, and an expected change in precipitation of the land site due to climate change.

18. The method of claim 12 wherein:
the database further has for each land site a soil health score that is indicative of a health of soil of the land site, and the risk score of the land site depends on the soil health score of the land site; and
the one or more products includes at least soil health control product which when applied to the land site will improve the health of the soil of the land site to increase the chance for vegetation on the land site to be sustained.

19. The method of claim 18 wherein:
the database further has for each land site a plurality of soil health factors, the soil heath score for each land site depending on the soil health factors of the land site, and the soil health factors for each land site includes a pH of the soil of the land site, a soil organic matter content of the soil of the land site, and a sodium adsorption ratio of the soil of the land site.

20. The method of claim 12 wherein:
the database further has for each land site an indication of an amount and a type of pollinator-dependent cropland within a given proximity of the land site; and
the one or more products includes at least pollinator enhancement product, depending on the amount and the type of the pollinator-dependent cropland, which when applied to the land site will increase pollination activities originating from the land site onto the pollinator-dependent cropland in a manner consistent with the chance for vegetation on the land site to be sustained being increased.
